(19) United States
(12) Patent Application Publication
(10) Pub. No.: US 2008/0189179 A1
(43) Pub. Date: Aug. 7, 2008

(54) System, Application and Method for Facilitating Online Advertising

(76) Inventors: Joseph Marouani, (US); Noam Fine, (US)

Correspondence Address: Professional Patent Solutions, P.O. BOX 654, HERZELIYA PITUACH, 46105, omitted

(21) Appl. No.: 11/777,299

(22) Filed: Jul. 13, 2007

Related U.S. Application Data
(60) Provisional application No. 60/888,091, filed on Feb. 4, 2007.

(51) Int. Cl. G06Q 30/00

(52) U.S. Cl. 705/14

(57) ABSTRACT

Disclosed is a system, application and method for providing online advertising. According to some embodiments of the present invention, a prediction engine functionally associated with an ad server is adapted to receive a partial user input and to predict a complete user input. The prediction engine may be integral with the ad server or may be connected to the ad server via one or more digital communication links. The prediction engine may transmit its results to an ad selection module, where the ad selection module may also be functionally associated with the ad server.

### RELATED APPLICATIONS

The present application claims priority from U.S. Provisional Patent Application Ser. No. 60/888,091 filed on Feb. 4, 2007 which Provisional Application is hereby incorporated by reference in its entirety.

### FIELD OF THE INVENTION

The present invention relates to the field of serving relevant advertisements, and more particularly to the prediction and display of relevant advertisements related to user action in search engines or other applications that accept user input.

### BACKGROUND

Advertising using web based media, such as banner advertising, text advertisements in search engines and in content websites is well known. Advertisers have used these types of media to reach a large audience with their advertisements (“ads”). To reach a more responsive audience, advertisers have used different contextual advertising options, such as the ones offered by Google (Adwords and Adsense) or Microsoft (Adcenter). For example, with the Google Adwords program, searching the word “apple” will lead to the display of apple related ads at a designated location on the search results page. However, even with such correlation, publishers are in need of a medium that will provide higher click rates (average click through rate was estimated at 1.5% in 2005 and 0.7% in 2006).

Dynamically displayed media, such as predictive queries sent to a search engine after a user types a partial search query, have the potential to receive better user attention. For example, a user typing a partial search query, might not complete typing the query if prior to that he is displayed with an attractive content, which has high correlation with the complete predicted query.

While systems such as Adwords and Adsense have provided advertisers the ability to better target ads, their effectiveness is limited to situations where the user is already viewing the content of his choice, for example, content websites or pages generated after a user has submitted a search query and viewing its results.

Dynamic display options offered on different websites, such as the “Google Suggest” mechanism have the limitation of extracting data originating from the same domain the mechanism is hosted on, as dictated by the “same-origin-policy” [http://en.wikipedia.org/wiki/Same_origin_policy]. This limitation is currently preventing the ability to offer such a mechanism to websites hosted on a remote server as a third party service.

It would be useful, therefore to have methods and apparatus for providing relevant ads prior to the completion of search queries or other user input content.

### SUMMARY OF THE INVENTION

The present invention is a system, application and method for providing online advertising. According to some embodiments of the present invention, a prediction engine functionally associated with an ad server may be adapted to receive a partial user input and to predict a complete user input. According to some embodiments of the present invention, predicted complete user input may be any one of: complete sentences, keywords, tokens, or any other means of representing the user's intention or general interest. According to further embodiments of the present invention, the prediction engine may also receive related data, such as but not limited to the originating website, the user's IP address, identifying tags, cookies, and/or any other data that may assist said prediction.

According to some embodiments of the present invention, the prediction engine may be integral with the advertising server. According to other embodiments of the present invention, the prediction engine may be connected to the ad server via one or more digital communication links. The prediction engine may transmit its results to an ad selection module, where the ad selection module may also be functionally associated with the ad server.

According to some embodiments of the present invention, an ad prediction engine may predict user input based on partial user input and/or related data. The partial user input may originate from an input field of an application (such as web browser), and may be transmitted to the prediction engine via one or more communication links. According to further embodiments of the present invention, the prediction engine may transmit the predicted user input and related data to an ad selection module.

According to some embodiments of the present invention, a predictive ad displaying application may include a communication module, adapted to transmit partial user input from an input field, and other related data to a server, and to receive predicatively selected ads (ads selected based on predicting the complete input) from an advertising server.

According to some embodiments of the present invention, the ad server may be separated from the server supplying the on-line content. According to further embodiments of the present invention, the ad server may by on a different domain from the server supplying the on-line content.

According to some embodiments of the present invention, a predictive ad displaying application may include a specialized background communication module, adapted to bypass the client's native means for background communication (e.g. XMLHttpRequest [http://en.wikipedia.org/wiki/XMLHttpRequest]), and therefore may overcome the same-origin policy limitation.

According to some embodiments of the present invention, a method for online advertising may comprise predicting a complete user input based on received partial user input and related data, and selecting an ad based on a result of said prediction.

According to some embodiments of the present invention, a method of displaying online advertising through a client application may comprise: sending partial user input from an input field on a client application, and other related data to an ad server; and displaying a predicatively selected ad received from the ad server.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram illustrating the data flow in an exemplary process in accordance with some embodiments of the present invention;

FIG. 2 is a block diagram illustrating the functional building blocks of an online client in accordance with some embodiments of the present invention;

FIG. 3 is a flowchart illustrating an exemplary method by which an advertising server provides dynamic advertisements correlated with partial user input from the viewpoint of an online client in accordance with some embodiments of the present invention;

FIG. 4 is a block diagram illustrating the functional building blocks of an advertising server in accordance with some embodiments of the present invention; and

FIG. 5 is a flowchart illustrating an exemplary method by which an advertising server provides dynamic advertisements correlated with partial user input from the viewpoint of an advertising server in accordance with some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

The present invention is a system, application and method for providing online advertising. According to some embodiments of the present invention, a prediction engine functionally associated with an ad server may be adapted to receive a partial user input and to predict a complete user input. According to some embodiments of the present invention, predicted complete user input may be any one of: complete sentences, keywords, tokens, or any other means of representing the user's intention or general interest. According to further embodiments of the present invention, the prediction engine may also receive related data, such as but not limited to the originating website, the user's IP address, identifying tags, cookies, and/or any other data that may assist said prediction.

According to some embodiments of the present invention, the prediction engine may be integral with the advertising server. According to other embodiments of the present invention, the prediction engine may be connected to the ad server via one or more digital communication links. The prediction engine may transmit its results to an ad selection module, where the ad selection module may also be functionally associated with the ad server.

According to some embodiments of the present invention, an ad prediction engine may predict user input based on partial user input and/or related data. The partial user input may originate from an input field of an application (such as web browser), and may be transmitted to the prediction engine via one or more communication links. According to further embodiments of the present invention, the prediction engine may transmit the predicted user input and related data to an ad selection module.

According to some embodiments of the present invention, a predictive ad displaying application may include a communication module, adapted to transmit partial user input from an input field, and other related data to a server, and to receive predicatively selected ads (ads selected based on predicting the complete input) from an advertising server.

According to some embodiments of the present invention, the ad server may be separated from the server supplying the on-line content. According to further embodiments of the present invention, the ad server may by on a different domain from the server supplying the on-line content.

According to some embodiments of the present invention, a predictive as displying application may include a specialized background communication module, adapted to bypass the client's native means for background communication (e.g. XMLHttpRequest [http://en.wikipedia.org/wiki/XMLHttpRequest]), and therefore may overcome the same-origin policy limitation.

According to some embodiments of the present invention, a method for online advertising may comprise predicting a complete user input based on received partial user input and related data, and selecting an ad based on a result of said prediction.

According to some embodiments of the present invention, a method of displaying online advertising through a client application may comprise: sending partial user input from an input field on a client application, and other related data to an ad server; and displaying a predicatively selected ad received from the ad server.

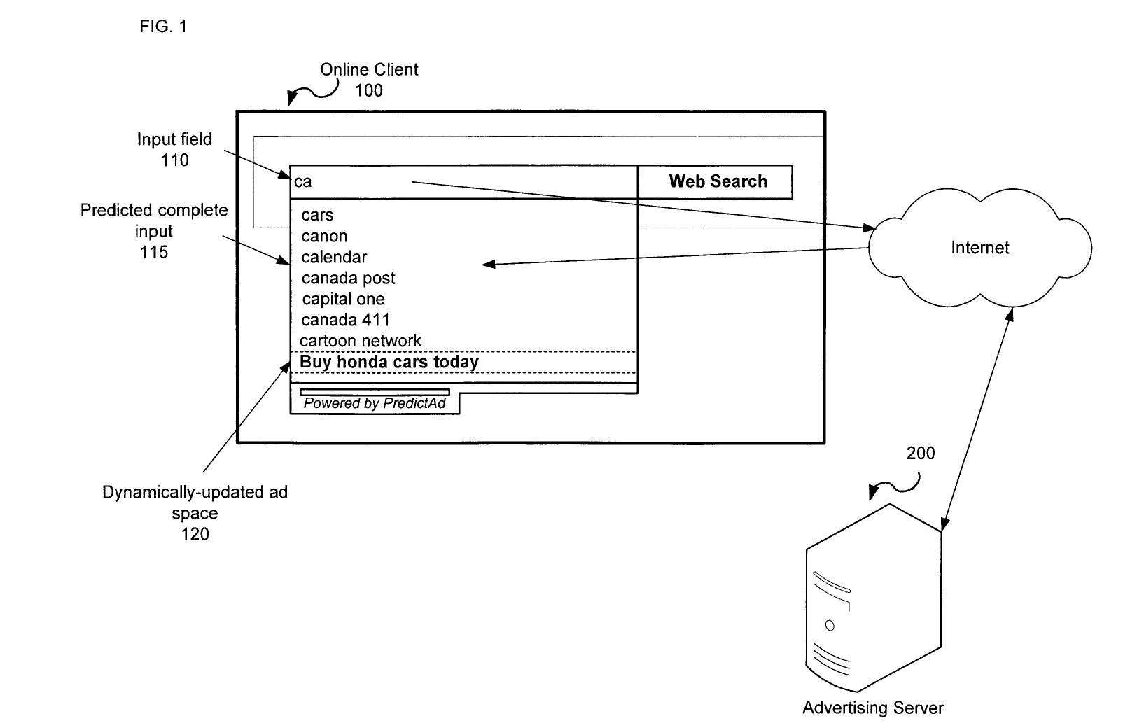

Reference is now made to FIG. 1, which is a block diagram illustrating the data flow in an exemplary process in accordance with some embodiments of the present invention. According to some embodiments of the present invention, updates to an input field 110 on a client application 100 may be forwarded to an ad server 200, which in return may send possible predicted complete input 115 and a relevant ad 120.

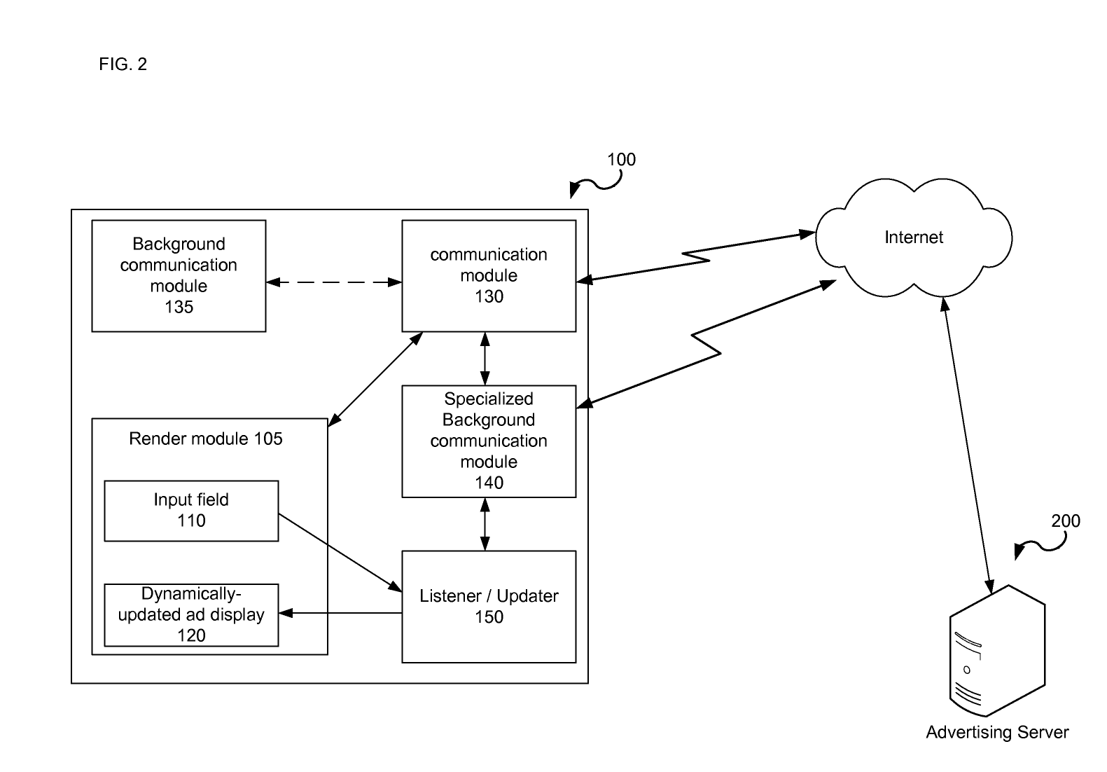

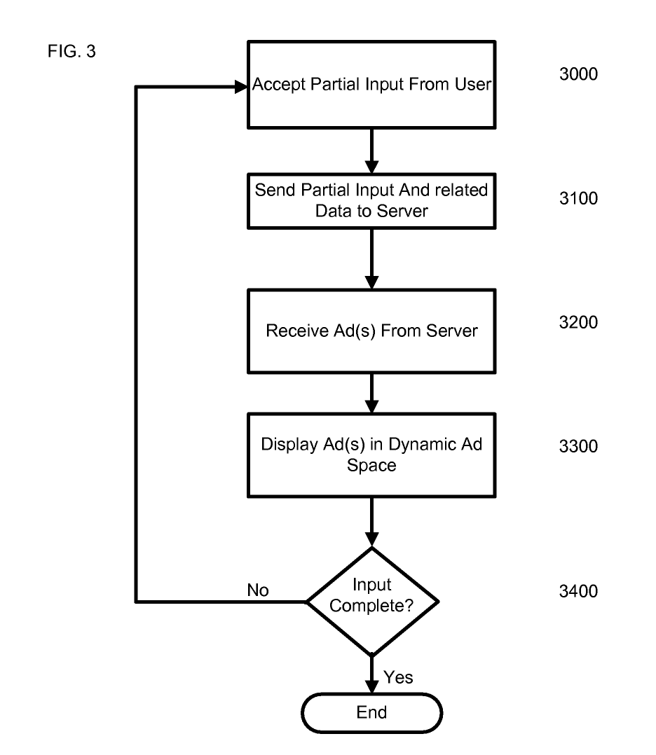

Reference is now made to FIG. 2, which is a block diagram illustrating the functional building blocks of an online client in accordance with some embodiments of the present invention, and to FIG. 3, which is a flowchart illustrating an exemplary method by which an advertising server provides dynamic advertisements correlated with partial user input from the viewpoint of an online client in accordance with some embodiments of the present invention. According to some embodiments of the present invention, a client browser 100 may receive a web page from a server via the communication module 130, and may display it by the rendering module 105. The web page may instruct the listener/updater 150 to collect partial user input via the input filed 110 (step 3000), and to forward to a server 200 via the specialized background communication module 140 (step 3100), bypassing the background communication module 135 due to its same-origin policy limitation. The ads received from the server 200 by the listener/updater 150 (step 3200) may be displayed in the dynamically-updated ad display 120 (step 3300). The process may be repeated every time the partial user input is updated (step 3400), until the user has indicated that the input is complete (e.g. by pressing enter).

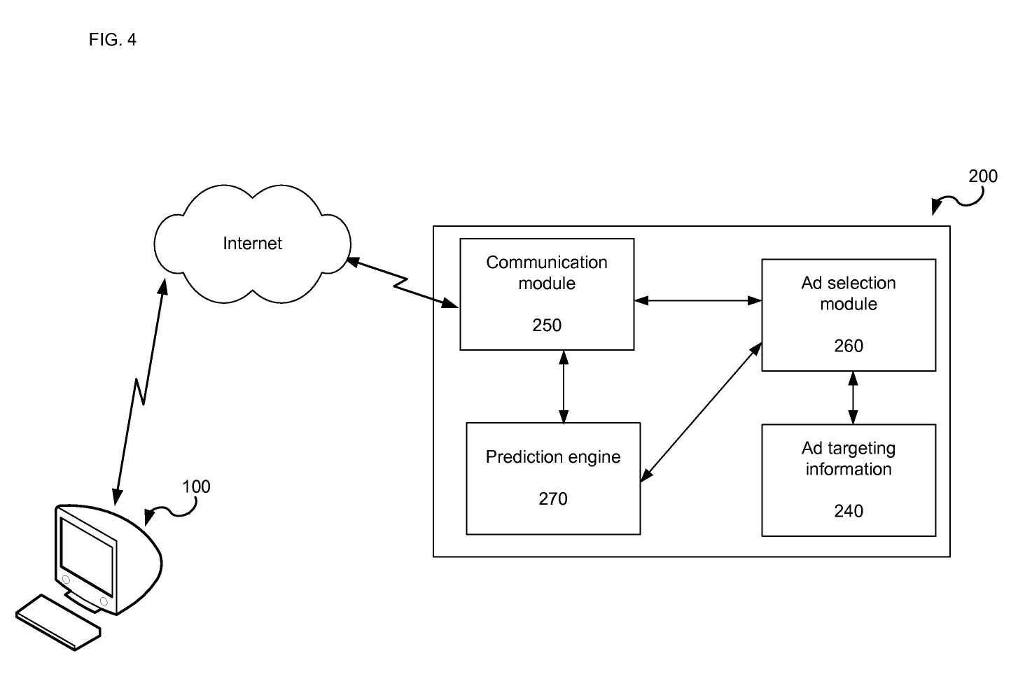

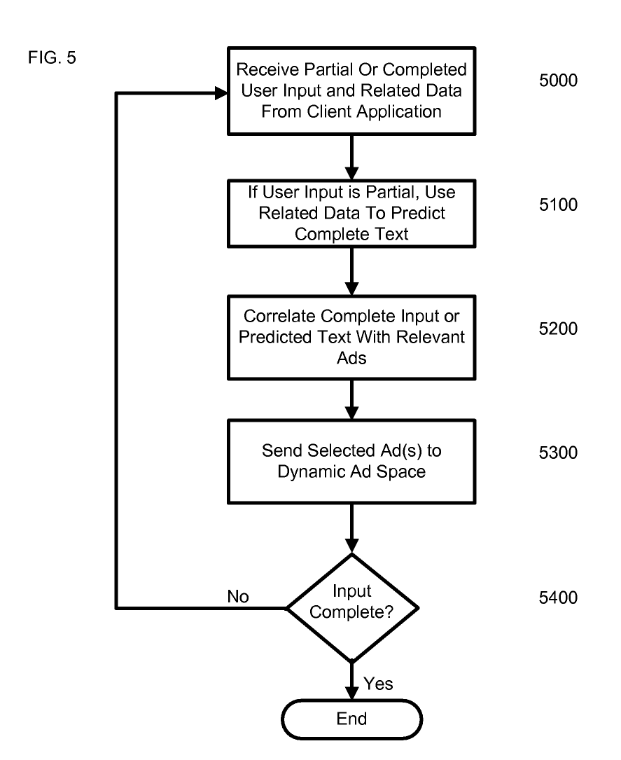

Reference is now made to FIG. 4, which is a block diagram illustrating the functional building blocks of an advertising server in accordance with some embodiments of the present invention, and to FIG. 5, which is a flowchart illustrating an exemplary method by which an advertising server provides dynamic advertisements correlated with partial user input from the viewpoint of an advertising server in accordance with some embodiments of the present invention. According to some embodiments of the present invention, a client browser 100 may send partial user input to an advertising server 200 via the communication module 250 (step 5000). If the received user input is not complete, it is forwarded to the prediction 270 for prediction of the complete text (step 5100). The completed text may then be forwarded to the ad selection module 260, where it may be correlated with ad targeting information 240 to select relevant ads (step 5200). The selected ads are then forwarded to the communication module 250 to be sent to the client browser 100 (step 5300). The process may be repeated every time the partial user input is updated (step 5400), until the user has indicated that the input is complete (e.g. by pressing enter).

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed:

1. An online advertising system comprising:
a prediction engine adapted to predict a user input based on a partial user input; and
an ad selection module adapted to select an ad based on a result of said prediction engine.

2. The system according to claim 1, further comprising a communication module adapted to receive partial user input, and to transmit the selected ad to the user.

3. The system according to claim 2, wherein said prediction engine is adapted to update the predicted user input as the partial user input is updated.

4. The system according to claim 1, further comprising an ad targeting table adapted to correlate between user input and selectable ads.

5. The system according to claim 4, wherein said ad targeting table is based on prior user activity.

6. A method for online advertising comprising:
predicting a complete user input based on received partial user input, and selecting an ad based on a result of said prediction.

7. The method of claim 6, wherein ad selection is performed by correlating predicted text with ad targeting information.

8. The method according to claim 6, further comprising sending the selected ad to a user.

9. The method according to claim 8, further comprising updating the predicted user input as the partial user input is updated.

10. The method according to claim 9, further comprising selecting and sending to the user an ad based on the updated predicted user input.

11. A predictive ad display application comprising:
a communication module adapted to transmit partial user inputs from an input field in said application to an external server, said communication module further adapted to receive an ad predicatively selected based on the transmitted partial user input.

12. An ad prediction engine adapted to predict a user input based on a partial user input received from an input field of an application, and said prediction engine further adapted to transmit the predicted user input to an ad selection module.

13. A method of displaying online advertising through a client browser application, said method comprising:
send from the client browser application to an ad server a partial user input from an input field; and
displaying a predicatively selected ad received from the ad server.
